(19) United States
(12) Patent Application Publication
(10) Pub. No.: US 2013/0149990 A1
(43) Pub. Date: Jun. 13, 2013

(54) Wireless Communication Apparatus for Emergency Situations

(71) Applicants: Kevin Otto, Milwaukee, WI (US); Marlon Zbigniew Kasprzyk, Winfield, IL (US)

(72) Inventors: Kevin Otto, Milwaukee, WI (US); Marlon Zbigniew Kasprzyk, Winfield, IL (US)

(21) Appl. No.: 13/708,911

(22) Filed: Dec. 7, 2012

Related U.S. Application Data
(60) Provisional application No. 61/567,715, filed on Dec. 7, 2011.

(51) Int. Cl. H04W 4/22

(52) U.S. Cl. 455/404.2; 455/404.1

(57) ABSTRACT

An apparatus that allows communication in critical incidents and/or other emergency situation utilizing a throw phone comprises a throw box, a headset, an on/off switch, a power supply source, connection ports, a plurality of electronic components, and a plurality of detective modules. The headset, the power supply source, and the plurality of electronic components are positioned within the throw box and electrically connected to each other. The headset allows a suspect to wirelessly communicate with a command unit where the command unit is controlled by a low enforcement agent. The throw phone allows the law enforcement agent to evaluate the surrounding of the throw phone and the suspect through the command unit. The plurality of detective modules provides additional information to the law enforcement agents so that safety precautions can be carried out for the safety of the suspect and the others involved.

The current application claims a priority to the U.S. Provisional Patent application Ser. No. 61/567,715 filed on Dec. 7, 2011.

### FIELD OF THE INVENTION

The present invention relates generally to an apparatus for providing communication. More specifically, this invention is an apparatus that provides wireless communication in critical and emergency situations.

### BACKGROUND OF THE INVENTION

There are many situations in which communication is vital. Oftentimes, during hostage/hostile situations, a perpetrator will barricade him/her-self inside. In order to communicate or monitor the situation, an officer has to either enter the facility or make contact with the perpetrator, which can be risky and dangerous. Communication between the office and the perpetrator is an important aspect of the negotiating process to minimize collateral damages. It is therefore an object of the present invention to provide an apparatus which allows wireless communication and monitoring during critical and/or emergency situations so that the offices can be well aware of the situation. It is a further object of the present invention to expand on the features found in existing throw phones.

### BRIEF DESCRIPTION OF THE DRAWINGS

FIG. 1 is a flow chart illustrating the network connection of the present invention with a command unit, where the network connection uses two different mobile networks.

FIG. 2 is a flow chart illustrating the network connection of the present invention with a command unit, where the network connection uses a single mobile network.

FIG. 3 is flow chart illustrating the plurality of electrical components of the preferred embodiment.

FIG. 4 is a flow chart illustrating the basic electronic connection of the present invention.

FIG. 5 is a perspective view the preferred embodiment of the present invention.

FIG. 6 is a basic schematic diagram of the plurality of electrical components of the preferred embodiment.

### DETAIL DESCRIPTIONS OF THE INVENTION

All illustrations of the drawings are for the purpose of describing selected versions of the present invention and are not intended to limit the scope of the present invention.

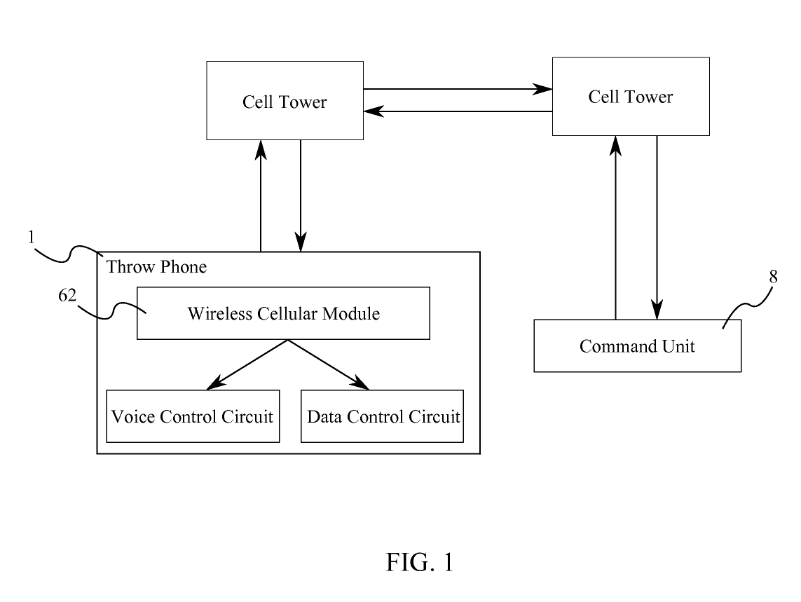

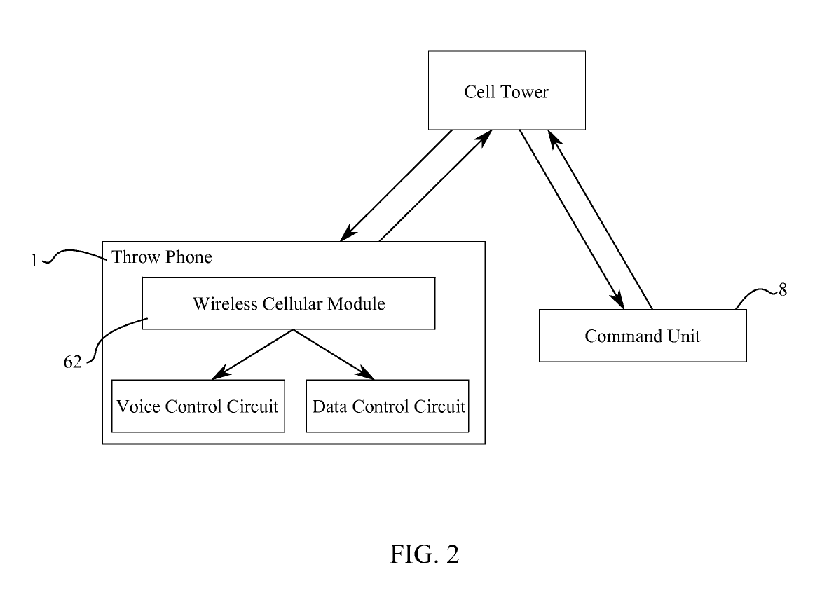

The present invention is a wireless communication apparatus for emergency situations that allows communication in critical incidents and/or other emergency situation utilizing electronic devices where the electronic devices include, but not limited to cellular phones, laptops, digital speakers, sensors, throw phones, and any other type of electronic or mechanical devices. The preferred embodiment of the present invention is illustrated within a throw phone. The throw phone is an electronic communication device which allows the law enforcement agents to communicate with a suspect during hostage negotiations. The throw phone can connect with a command unit 8, where the command unit 8 is operated by the law enforcement agents, utilizing a land-line telephone network, a mobile network or a computer modem. In reference to FIG. 1 and FIG. 2, the preferred embodiment of the present invention wirelessly connects with the command unit 8 using single mobile network or multiple mobile networks as a full duplex communication system.

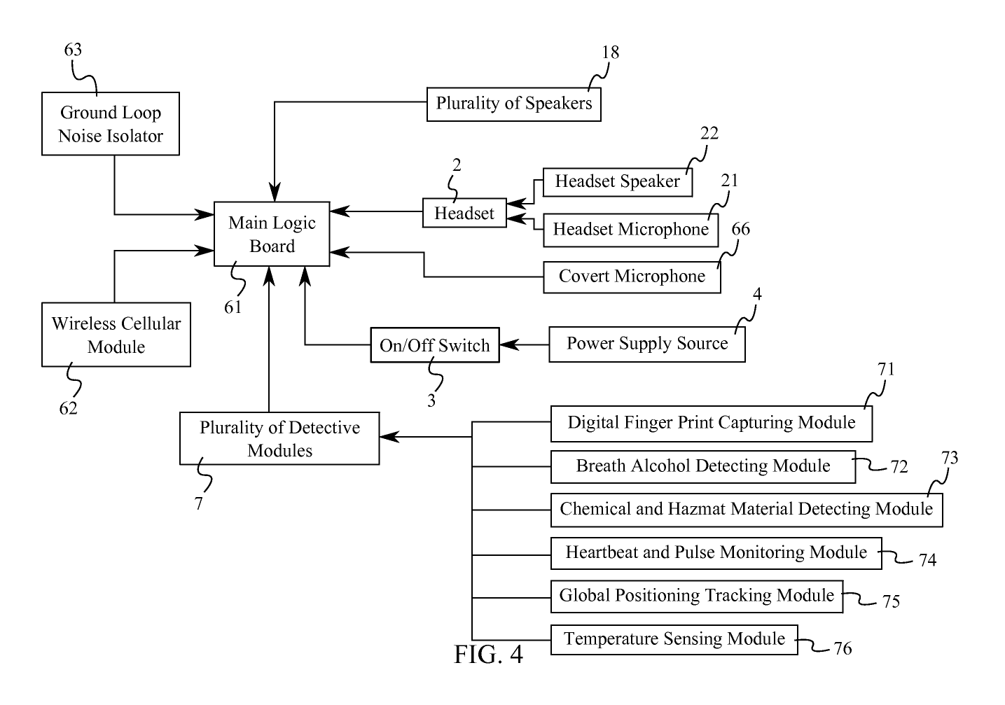

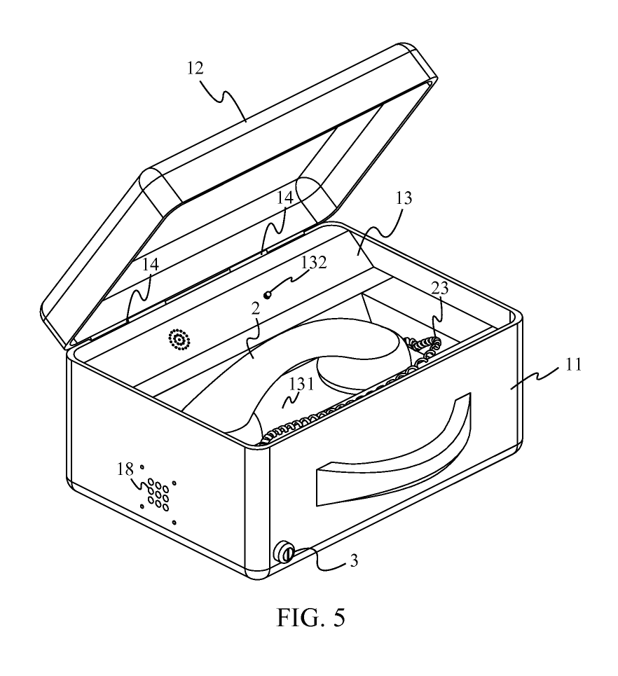

In reference to FIG. 4 and FIG. 5, the preferred embodiment comprises a throw box 1, a headset 2, an on/off switch 3, a power supply source 4, connection ports 5, a plurality of electronic components 6, and a plurality of detective modules 7. The throw box 1 comprises a lower casing 11, a cover 12, an interior panel 13, hinges 14, a pair of latches 15, a cradle 16, and a plurality of speakers 18. The lower casing 11 has a rectangular box shape where the lower casing 11 houses the power supply source 4 and the plurality of electronic components 6. The cover 12 is pivotably connected to the lower casing 11 from the back end by the hinges 14, and the pair of latches 15 locks the cover 12 to the lower casing 11 and unlocks the cover 12 from the lower casing 11 from the front end. The cover 12 can be moved in between a closed position and an opened position along the hinges 14. The interior panel 13 is positioned within the lower casing 11 and adjacently positioned with the cover 12. When the cover 12 is at the opened position, the interior panel 13 is displayed to the user within the lower casing 11. The interior panel 13 centrally comprises a headset cavity 131 and an indicator light 132. The headset cavity 131 of the preferred embodiment provides secured place so that the headset 2 of the preferred embodiment can be placed within the headset cavity 131. The indicator light 132 of the preferred embodiment visually demonstrate the current states of the present invention. The cradle 16 of the preferred embodiment is positioned on the lower casing 11, but the cradle 16 can be positioned on either the lower casing 11 or the cover 12. The cradle 16 is used by users to carry the preferred embodiment. The lower casing 11, the cover 12, the interior panel 13, the hinges 14, the pair of latches 15, and the cradle 16 can be made from high strength metal, hard plastic or any other type of high strength materials so that the throw box 1 can be tossed around while protecting all of the interior components. The plurality of speakers 18 is positioned around the lower casing 11 where the plurality of speakers 18 distributes sound to the user when the cover 12 is at the closed position or the opened position.

The headset 2 comprises a headset microphone 21, a headset speaker 22, and an extension wire cord 23. The headset microphone 21 and the headset speaker 22 are positioned within the headset 2 similar to the ordinary hand held telephone headset. When the headset 2 is not used by a user, the headset 2 is securely placed within the headset cavity 131. The extension wire cord 23 comprises a speaker wire cord 24 and a microphone wire cord 24. The speaker wire cord 24 is electronically connected to the headset speaker 22, and the microphone wire cord 24 is electronically connected to the headset microphone 21. The extension wire cord 23 is extended from the headset 2 and traversed through the interior plane. The extension wire cord 23 transmits sounds from the headset microphone 21 and channels sound to the headset speaker 22. The on/off switch 3 is positioned on the lower casing 11 where the on/off switch 3 can be switched in between on-position and off-position by a designated key, a push button mechanism, a flip button mechanism or any other type of mechanism. The on/off switch 3 of the preferred embodiment electronically completes or incomplete a power supply circuit of the power supply source 4. When the on/off switch 3 is at the on-position, the indicator light 132 turns on, where the indicator light 132 visually demonstrates that the preferred embodiment is at the on-position. When the on/off switch 3 is at the off-position, the indicator light 132 turns off, where the indicator light 132 visually demonstrates that the preferred embodiment is at the off-position.

The power supply source 4 of the preferred embodiment is a direct current wherein rechargeable batteries are used as the power supply source 4. Although rechargeable batteries are used as the power supply source 4 of the preferred embodiment, the present invention can be powered from any desired power source such as alternative current or solar energy. The power supply source 4 provides the necessary power to the preferred embodiment so that the preferred embodiment is able to function.

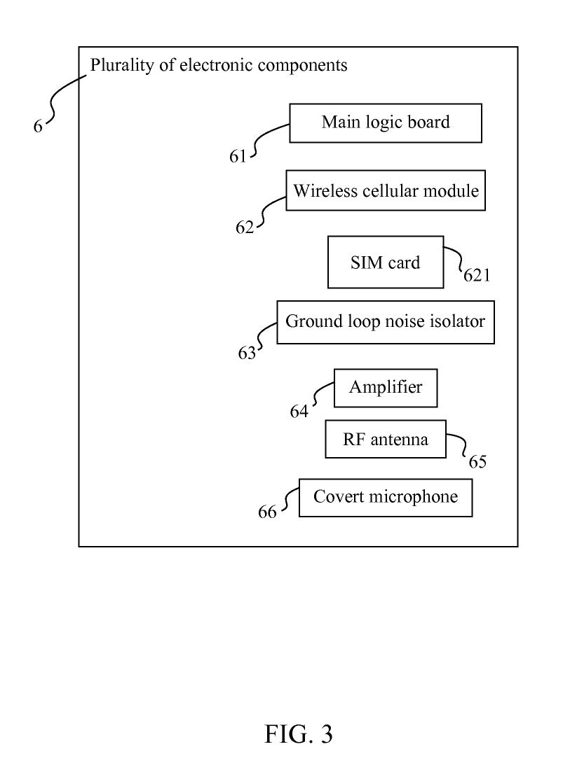

In reference to FIG. 3, the plurality of electronic components 6 comprises a main logic board 61, a wireless cellular module 62, a ground loop noise isolator 63, an amplifier 64, a radio frequency (RF) antenna 65, and a covert microphone 66. The main logic board 61 is a printed circuit board (PCB) where the PCB includes proprietary hardware and software for the proper functionality. The main logic board 61 of the preferred embodiment functions through a voice control circuit and a data control circuit. The voice control circuit performs all of the audio data transferring of the headset 2, the plurality of speakers 18, and the covert microphone 66. The data control circuit sends and receives commands and data from the connection ports 5, the plurality of electronic components 6, and the plurality of detective modules 7. The wireless cellular module 62 is electronically connected with the main logic board 61. The wireless cellular module 62 is able to wirelessly connect the preferred embodiment with any mobile network. The wireless cellular module 62 comprises a subscriber identity module (SIM) card 621. The SIM card 621 is inserted into the wireless cellular module 62 where the SIM card 621 is electronically connected with the wireless cellular module 62. The ground loop noise isolator 63 is electronically connected with the main logic board 61 where the ground noise isolator 63 removes unnecessary noises from the generated signals of the preferred embodiment.

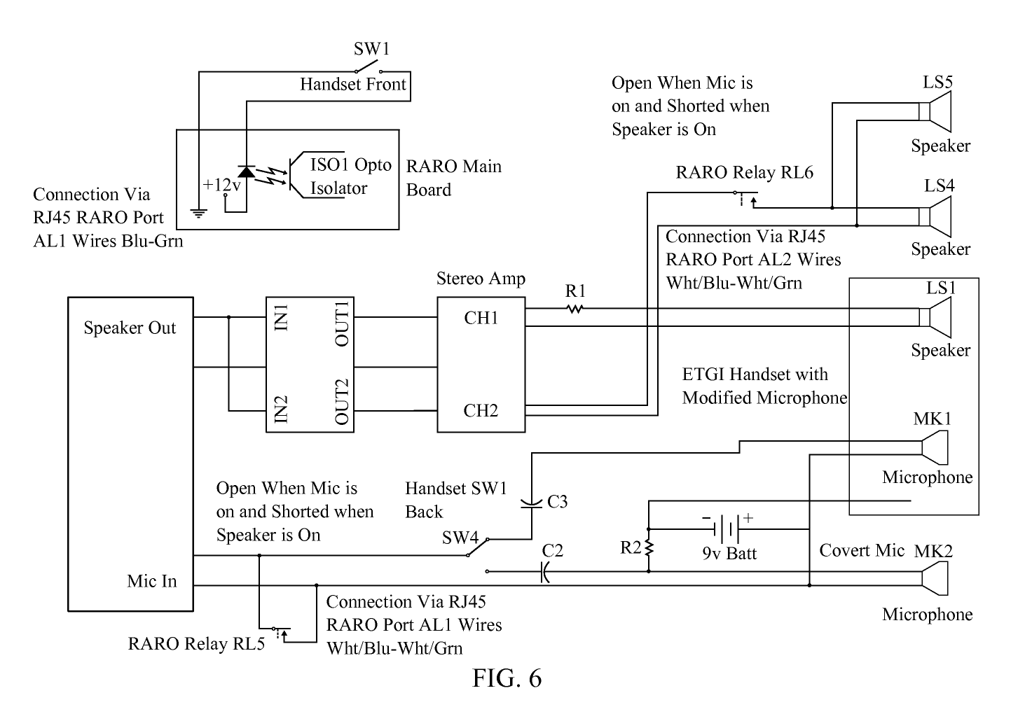

In reference to FIG. 6, the amplifier 64 is electronically connected to the main logic board 61 where the amplifier 64 comprises a first channel input, a first channel output, a second channel input, and a second channel output. The RF antenna 65 is electronically connected with the main logic board 61. The covert microphone 66 is electronically connected with the wireless cellular module 62 where the covert microphone 66 is hidden within the lower casing 11 and adjacent to the interior panel 13. The first channel input and the second channel input of the amplifier 64 are electronically connected to the wireless cellular module 62. The first channel output of the amplifier 64 is electronically connected to with the speaker wire cord 24, and the second channel output of the amplifier 64 is electronically connected with the plurality of speakers 18. The covert microphone 66 and the microphone wire code are electronically connected into a selection switch where the selection switch is electronically connected to the wireless cellular module 62. When the headset 2 is used by a user, the main logic board 61 electronically connects the selection switch with the microphone wire code where the audio data is received to the user through the headset speaker 22 and sent through the headset microphone 21 by the user. When the headset 2 is not used by a user, the main logic board 61 electronically connects the selection switch with the covert microphone 66 activating the covert microphone 66. The covert microphone 66 allows the law enforcement agent to secretly listen into the surround audio data of the preferred embodiment through the command unit 8 by utilizing a half-duplex communication system. Simultaneously, the selection switch activates the plurality of speakers 18 so that the law enforcement agents can speak to the suspect through the command unit 8 by utilizing a half-duplex communication system. The power supply source 4 electronically connects with the main logic board 61 when the on/off switch 3 is at the on-position and disconnects from the main logic board 61 when the on/off switch 3 is at the off-position. The main logic board 61 redirects power from the power supply source 4 to the electronic components when the on/off switch 3 is at the on-position.

The plurality of detective modules 7 of the preferred embodiment comprises a digital finger print capturing module 71, a breath-alcohol detecting module 72, a chemical and hazmat material detecting module 73, a heartbeat and pulse monitoring module 74, a global positioning tracking module 75, and a temperature sensing module 76. When the preferred embodiment is used by a suspect, the suspect needs to carry the preferred embodiment by the cradle 16, open the cover 12 by unlocking the pair of latches 15, and hold the headset 2 to speak and listen. While the suspect uses his or her hands around the cradle 16, the pair of latches 15, and the headset 2 during usage of the preferred embodiment, the digital finger print capturing module 71 is able to produce finger prints of the suspect. The digital finger print capturing module 71 of the preferred embodiment is covertly positioned on the headset 2 since the headset 2 is constantly used by the suspect, and the digital finger print capturing module 71 is electronically connected with the main logic board 61. In order to increase the probability of capturing finger prints, many digital finger print capturing modules 71 can be covertly hidden adjacent to the cradle 16, the pair of latches 15, and the headset 2. Once the digital finger print capturing module 71 captures one or more fingerprints, the captured fingerprints are instantaneously processed by the main logic board 61 and sent to the command unit 8 through the wireless cellular module 62. The captured fingerprints allow the law enforcement agents to quickly identify the suspect so that proper protocols and safety measures can be carried out for the safety of the hostages and the suspect.

The breath-alcohol detecting module 72 of the preferred embodiment is positioned within the headset 2 and adjacently positioned with the headset speaker 22. When a suspect speaks into the headset 2, the breath-alcohol detecting module 72 is able to detect the breath alcohol percentage of the suspect so that the law enforcement agents have a better understanding of the actual situation. If the breath-alcohol detecting module 72 detects that the suspect has consumed alcohol, the results are processed by the main logic board 61 and sent to the command unit 8 through the wireless cellular module 62.

The chemical and hazmat material detecting module 73 of the preferred embodiment is positioned within the lower casing 11 where the chemical and hazmat material detecting module 73 senses any type of hazardous materials around the surrounding areas of the preferred embodiment. Since the chemical and hazmat material detecting module 73 provides real time actual data, the law enforcement agents are able quickly to act upon any problems. For example, when a suspect is threatening to burn down an office building with hostages where the law enforcement agents can't get a clear view of the actual situation, the law enforcement agent needs to react quickly. If the law enforcement agents are able to receive any data about the presence of gasoline through the chemical and hazmat material detecting module 73, the law enforcement agent can assess the actual situation and take necessary precautions. Once the chemical and hazmat material detecting module 73 detects any hazardous materials, the information is processed by the main logic board 61 and sent to the command unit 8 through the wireless cellular module 62.

The heartbeat and pulse monitoring module 74 of the preferred embodiment is positioned on the headset 2 in between the headset microphone 21 and the headset speaker 22. The heartbeat and pulse monitoring module 74 is able to measure the heartbeat and the pulse of a suspect while the suspect holds the headset 2. This allows the law enforcement agents to identify the state of mind of the suspect so that efficient negotiation process can be carried out. Once the heartbeat and pulse monitoring module 74 measures the heartbeat and the pulse rate of the suspect, the information is processed by the main logic board 61 and sent to the command unit 8 through the wireless cellular module 62.

The global positioning tracking module 75 is electronically connected with the main logic board 61 where the global positioning tracking module 75 calculates the precision location of the preferred embodiment continuously. The global positioning tracking module 75 is covertly positioned within the lower casing 11 and the interior panel 13. The main logic board 61 sends the updated information to the command unit 8 through the wireless cellular module 62. For example, if a suspect decides to flee from the situation with the preferred embodiment, the law enforcement agents can track the position of suspect by using the global positioning tracking module 75. The temperature sensing module 76 can be positioned within the lower casing 11 and electronically connected with the main logic board 61. The temperature sensing module 76 constantly measures the temperature around the preferred embodiment and sends to the command unit 8 through main logic board 61 and the wireless cellular module 62.

The connection ports 5 of the preferred embodiment comprise ethernet ports, a phone line port, and universal serial bus (USB) ports. If the user decides to use the preferred embodiment utilizing the land-line telephone network, the land-line telephone network is connected with the phone line port. The phone line port is positioned on the lower casing 11 and electronically connected with the main logic board 61. The ethernet ports and the USB ports are also positioned on the lower casing 11 and electronically connected with the main logic board 61. The ethernet ports and the USB ports respectively allow the preferred embodiment to connect with the computer modem and optional external components such as video cameras and a text messaging module. The video cameras can be electrically connected with the preferred embodiment through the USB ports so that the law enforcement agents are able to get video data as additional resources. The text messaging module can also electronically connect with the preferred embodiment through the USB ports so that a suspect and the law enforcement agents can communicate with text messages. The text messaging module may comprises a display panel and telephone keypad where the display panel allows the suspect read any received text massages, and the telephone keypad allows the suspect to write any text messages. Since the USB ports are electronically connected with the main logic board 61, data from the USB ports are processed through the main logic board 61 and sent to the command unit through the wireless cellular module 62.

The present invention can also retrofit to function with different environments including, but not limited to, automobiles, houses, schools, electronic speakers, and floating devices. Depending on the environment and the surrounding, the present invention can be attached as an attachment to existing features or can be built into the new features.

Although the invention has been explained in relation to its preferred embodiment, it is to be understood that many other possible modifications and variations can be made without departing from the spirit and scope of the invention as hereinafter claimed.

What is claimed is:

1. A wireless communication apparatus for emergency situations comprises,
a throw box;
a headset;
on/off switch;
a power supply source;
a plurality of electronic components;
a plurality of detective modules;
the throw box comprises a lower casing, a cover, interior panel, and a headset cavity;
the headset comprises a headset microphone, a headset speaker, and an extension wire cord; and
the plurality of electronic components comprises a main logic board, a wireless cellular module, a subscriber identity module (SIM) card, a ground loop noise isolator, an amplifier, a radio frequency (RF) antenna, and a covert microphone.

2. The wireless communication apparatus for emergency situations as claimed in claim 1 comprises,
the lower casing being positioned below the cover;
the lower casing being pivotably connected to the cover;
the interior panel being positioned within the lower casing and adjacent with the cover;
the headset cavity being centrally positioned on the interior panel; and
the headset being positioned within the headset cavity.

3. The wireless communication apparatus for emergency situations as claimed in claim 1 comprises,
the headset microphone and the headset speaker being oppositely positioned on the headset;
the headset microphone and the headset speaker being positioned within the headset;
the extension wire cord being positioned in between the headset and the interior panel; and
the extension wire cord being connected to the headset and the interior panel.

4. The wireless communication apparatus for emergency situations as claimed in claim 1 comprises,
the on-off switch being positioned on the lower casing;
the power supply source being positioned within the lower casing;
the main logic board, the wireless cellular module, the subscriber identity module (SIM) card, the ground loop noise isolator, and the amplifier being positioned within the lower casing and the interior panel;
the radio frequency (RF) antenna being positioned on the lower casing; and
the covert microphone being adjacently positioned with the interior panel.

5. The wireless communication apparatus for emergency situations as claimed in claim 1 comprises,
the wireless cellular module being electronically connected with the main logic board;
the subscriber identity module (SIM) card being inserted into the wireless cellular module and electronically connected with the wireless cellular module;
the ground loop isolator being electronically connected with the main logic board;
the amplifier being electronically connected with the main logic board;
the radio frequency (RF) antenna being electronically connected with the main logic board;
the covert microphone being electronically connected with the wireless cellular module; and
the on/off switch being electronically connected in between the main logic board and the power supply source.

6. The wireless communication apparatus for emergency situations as claimed in claim 5 comprises,
the covert microphone and the headset microphone being electronically coupled to each other, wherein only the headset microphone is powered when the headset is in use, and only the covert microphone is powered when the headset is not in use.

7. The wireless communication apparatus for emergency situations as claimed in claim 1 comprises,
the plurality of detective modules comprises a digital print capturing module, a breath-alcohol detecting module, a chemical and hazmat material detecting module, a heartbeat and pulse monitoring module, a global positioning tracking module, and a temperature sensing module;
the digital print capturing module being electronically connected with the main logic board;
the breath-alcohol detecting module being electronically connected with the main logic board;
the chemical and hazmat material detecting module being electronically connected with the main logic board;
the heartbeat and pulse monitoring module being electronically connected with the main logic board;
the global positioning tracking module being electronically connected with the main logic board; and
the temperature sensing module being electronically connected with the main logic board.

8. A wireless communication apparatus for emergency situations comprises,
a throw box;
a headset;
on/off switch;
a power supply source;
a plurality of electronic components;
a plurality of detective modules;
the throw box comprises a lower casing, a cover, interior panel, and a headset cavity;
the headset comprises a headset microphone, a headset speaker, and an extension wire cord;
the plurality of electronic components comprises a main logic board, a wireless cellular module, a subscriber identity module (SIM) card, a ground loop noise isolator, an amplifier, a radio frequency (RF) antenna, and a covert microphone;
the plurality of detective modules comprises a digital print capturing module, a breath-alcohol detecting module, a chemical and hazmat material detecting module, a heartbeat and pulse monitoring module, a global positioning tracking module, and a temperature sensing module;
the lower casing being positioned below the cover;
the lower casing being pivotably connected to the cover;
the interior panel being positioned within the lower casing and adjacent with the cover;
the headset cavity being centrally positioned on the interior panel; and
the headset being positioned within the headset cavity.

9. The wireless communication apparatus for emergency situations as claimed in claim 8 comprises,
the headset microphone and the headset speaker being oppositely positioned on the headset;
the headset microphone and the headset speaker being positioned within the headset;
the extension wire cord being positioned in between the headset and the interior panel; and
the extension wire cord being connected to the headset and the interior panel.

10. The wireless communication apparatus for emergency situations as claimed in claim 8 comprises,
the on-off switch being positioned on the lower casing;
the power supply source being positioned within the lower casing;
the main logic board, the wireless cellular module, the subscriber identity module (SIM) card, the ground loop noise isolator, and the amplifier being positioned within the lower casing and the interior panel;
the radio frequency (RF) antenna being positioned on the lower casing; and
the covert microphone being adjacently positioned with the interior panel.

11. The wireless communication apparatus for emergency situations as claimed in claim 8 comprises,
the wireless cellular module being electronically connected with the main logic board;
the subscriber identity module (SIM) card being inserted into the wireless cellular module and electronically connected with the wireless cellular module;
the ground loop isolator being electronically connected with the main logic board;
the amplifier being electronically connected with the main logic board;
the radio frequency (RF) antenna being electronically connected with the main logic board;
the covert microphone being electronically connected with the wireless cellular module; and
the on/off switch being electronically connected in between the main logic board and the power supply source.

12. The wireless communication apparatus for emergency situations as claimed in claim 8 comprises,
the covert microphone and the headset microphone being electronically coupled to each other, wherein only the headset microphone is powered when the headset is in use, and only the covert microphone is powered when the headset is not in use.

13. The wireless communication apparatus for emergency situations as claimed in claim 8 comprises,
the digital print capturing module being electronically connected with the main logic board;
the breath-alcohol detecting module being electronically connected with the main logic board;
the chemical and hazmat material detecting module being electronically connected with the main logic board;
the heartbeat and pulse monitoring module being electronically connected with the main logic board;
the global positioning tracking module being electronically connected with the main logic board; and
the temperature sensing module being electronically connected with the main logic board.

14. A wireless communication apparatus for emergency situations comprises,
a throw box;
a headset;
on/off switch;
a power supply source;
a plurality of electronic components;
a plurality of detective modules;
the throw box comprises a lower casing, a cover, interior panel, and a headset cavity;
the headset comprises a headset microphone, a headset speaker, and an extension wire cord;
the plurality of electronic components comprises a main logic board, a wireless cellular module, a subscriber identity module (SIM) card, a ground loop noise isolator, an amplifier, a radio frequency (RF) antenna, and a covert microphone;
the plurality of detective modules comprises a digital print capturing module, a breath-alcohol detecting module, a chemical and hazmat material detecting module, a heartbeat and pulse monitoring module, a global positioning tracking module, and a temperature sensing module;
the lower casing being positioned below the cover;
the lower casing being pivotably connected to the cover;
the interior panel being positioned within the lower casing and adjacent with the cover;
the headset cavity being centrally positioned on the interior panel;
the headset being positioned within the headset cavity;
the headset microphone and the headset speaker being oppositely positioned on the headset;
the headset microphone and the headset speaker being positioned within the headset;
the extension wire cord being positioned in between the headset and the interior panel; and
the extension wire cord being connected to the headset and the interior panel.

15. The wireless communication apparatus for emergency situations as claimed in claim 14 comprises,
the on-off switch being positioned on the lower casing;
the power supply source being positioned within the lower casing;
the main logic board, the wireless cellular module, the subscriber identity module (SIM) card, the ground loop noise isolator, and the amplifier being positioned within the lower casing and the interior panel;
the radio frequency (RF) antenna being positioned on the lower casing; and
the covert microphone being adjacently positioned with the interior panel.

16. The wireless communication apparatus for emergency situations as claimed in claim 14 comprises,
the wireless cellular module being electronically connected with the main logic board;
the subscriber identity module (SIM) card being inserted into the wireless cellular module and electronically connected with the wireless cellular module;
the ground loop isolator being electronically connected with the main logic board;
the amplifier being electronically connected with the main logic board;
the radio frequency (RF) antenna being electronically connected with the main logic board;
the covert microphone being electronically connected with the wireless cellular module; and
the on/off switch being electronically connected in between the main logic board and the power supply source.

17. The wireless communication apparatus for emergency situations as claimed in claim 16 comprises,
the covert microphone and the headset microphone being electronically coupled to each other, wherein only the headset microphone is powered when the headset is in use, and only the covert microphone is powered when the headset is not in use.

18. The wireless communication apparatus for emergency situations as claimed in claim 14 comprises,
the digital print capturing module being electronically connected with the main logic board;
the breath-alcohol detecting module being electronically connected with the main logic board;
the chemical and hazmat material detecting module being electronically connected with the main logic board;
the heartbeat and pulse monitoring module being electronically connected with the main logic board;
the global positioning tracking module being electronically connected with the main logic board; and
the temperature sensing module being electronically connected with the main logic board.
